(19) United States
(12) Patent Application Publication
(10) Pub. No.: US 2025/0270048 A1
(43) Pub. Date: Aug. 28, 2025

(54) AUTOMATIC LOGISTICS SORTING APPARATUS INCLUDING LNB SORTERS

(71) Applicant: HOGUNL&S Co., Ltd., Hwaseong-si (KR)

(72) Inventor: Haesoo LEE, Seoul (KR)

(21) Appl. No.: 19/055,392

(22) Filed: Feb. 17, 2025

(30) Foreign Application Priority Data
Feb. 26, 2024 (KR) 10-2024-0027428

(51) Int. Cl. B65G 17/00; B07C 3/08; B65G 47/50

(52) U.S. Cl. CPC B65G 17/005; B07C 3/08; B65G 47/503

(57) ABSTRACT

The present invention provides an automatic logistics sorting apparatus including LNB sorters. The automatic logistics sorting apparatus includes: a transfer conveyor configured such that a plurality of LNB sorters spaced apart from each other by a predetermined distance are installed in the form of an endless track in order to transfer the products in one direction; LNB sorters configured to sort and discharge the products in a direction orthogonal to the moving direction of the transfer conveyor; a wireless communicator installed in each of the LNB sorters in order to enable wireless communication with a server so that the products can be sorted in a direction orthogonal to the transfer conveyor; and a power connection unit installed to supply power to the wireless communicator and the roller motor that are installed on the LNB sorter.

### CROSS-REFERENCE TO RELATED APPLICATION

This application claims the benefit of Korean Patent Application No. 10-2024-0027428 filed on Feb. 26, 2024, which is hereby incorporated by reference herein in its entirety.

### BACKGROUND

### 1. Technical Field

The present invention relates to automatic logistics sorting apparatus including linear narrow belt (LNB) sorters, and more specifically, to automatic logistics sorting apparatus including LNB in sorters, which a conveyor configured to transfer products is formed of sorters having a narrow width and products are sorted by the LNB sorters that are self-driven while transferring the products in a desired direction.

### 2. Description of the Related Art

The term “logistics” is another term for physical distribution, and is a general term for the functions or activities that effectively move products and goods from producers to consumers. In other words, logistics refers to various activities such as packaging, unloading, transportation, storage, and information.

Usually, transporting products and goods involves several processes such as packaging, storage, collection/loading, transportation, unloading/delivery, and storage. Regardless of the means of transportation used, the movement of products and goods is impossible without going through these processes. The overall procedure of this movement is physical distribution (logistics).

In recent years, mass production, mass sales, and mass consumption have become the trends of the times and the need to streamline the flow of materials between them has grown, so that the importance of logistics is gradually increasing.

A logistics warehouse is a storage warehouse for the temporary or long-term storage of all products used in daily life such as various types of foodstuffs, beverages, clothing, home appliances, miscellaneous products, and industrial products, which are mass-produced at factories or production sites.

Due to the rapid development of the logistics industry, these logistics warehouses are designed and constructed to go beyond simple logistics management and to create new businesses such as inventory management as well as efficient inventory placement and efficient receipt and delivery.

Since the rapid receipt and delivery of cargo is essential for such logistics warehouses, most of the logistics warehouses are equipped with mechanized or automated cargo loading and unloading means. Representative examples of the mechanized or automated cargo loading and unloading means include automated equipment such as stacker cranes, shuttles, and lifts.

In addition, there are also used sorter systems capable of automatically sorting various types of cargoes according to specific sorting criteria set by users.

The sorters have the transfer speed, width of the transfer conveyor belt, and transfer method that vary according to the volume of the cargo being transferred in order to optimize the transfer function. Accordingly, when cargo is received in individual sorters, the cargo is sorted by volume to be suitable for each sorter and then received.

However, the conventional previous volume sorting work for sorting cargo by sorter is done by manpower. Accordingly, there arise problems in that reliability is low due to the limitations of manual work and uniform sorting is difficult due to different criteria of individual workers.

There are further problems in that the work speed is slow, the amount of cargo received by each sorter varies depending on the skill level of the worker, and there is a concern that industrial accidents may occur for workers due to long-term repeated work.

Meanwhile, the applicant of the present application disclosed an “Automatic Logistics Sorting Apparatus” as described in Korean Patent No. 10-2607958. The “Automatic Logistics Sorting Apparatus” sorts products through the rotation of bevel gears installed on a cross-transfer conveyor while moving the cross-transfer conveyor by a sprocket driven by a motor.

The automatic logistics sorting apparatus including a bevel gear structure generates noise as it drives the bevel gears together with the conveyor, which causes the problem of not creating a pleasant working environment.

In addition, the automatic logistics sorting apparatus is formed of a chain and sprocket structure, so that there is the inconvenience of having to adjust the tension of a chain during use and also there is a problem in that the work time increases due to the tension adjustment.

### Related Art Literature

Patent Document 1: Korean Patent No. 10-2607958
Patent Document 2: Korean Patent No. 10-2170705
Patent Document 3: Korean Patent No. 10-1832142

### SUMMARY

The present invention has been conceived to overcome the above-described problems, and an object of the present is to provide an automatic logistics sorting invention apparatus including LNB sorters, in which a transfer conveyer configured to transfer products is formed of a plurality of LNB sorters and the transfer conveyor may be rotated in the form of an endless tack by electromagnets installed in the respective sorters.

Another object of the present invention is to provide an automatic logistics sorting apparatus including LNB sorters, in which wireless communicators configured to enable the wirelessly communication of the LNB sorters with a server are installed and the operations of the sorters may be controlled by means of wireless communication.

Still another object of the present invention is to provide an automatic logistics sorting apparatus including LNB sorters, in which the noise generated from the automatic logistics sorting apparatus and the LNB sorters may be reduced by driving a transfer conveyor by electromagnets installed in the LNB sorters and electromagnets installed in the transfer conveyor.

In order to accomplish the above objects, the present invention provides an automatic logistics sorting apparatus sorters, the automatic logistics sorting including LNB apparatus sorting a plurality of products while transferring the plurality of products, the automatic logistics sorting apparatus including: a transfer conveyor configured such that a plurality of LNB sorters spaced apart from each other by a predetermined distance are installed in the form of an endless track in order to transfer the products in one direction; LNB sorters configured to sort and discharge the products in a direction orthogonal to the moving direction of the transfer conveyor; a wireless communicator installed in each of the LNB sorters in order to enable wireless communication with a server so that the products can be sorted in a direction orthogonal to the transfer conveyor; and a power connection unit installed to supply power to the wireless communicator and the roller motor that are installed on the LNB sorter; wherein, when the LNB sorters reach a sorting location for the products, the products are sorted by driving the LNB sorters in response to signals received from the wireless communicators.

The transfer conveyor may include a power supply rail installed in an endless track form on horizontal frames in order to supply power to the LNB sorters, and transfer electromagnets installed on the horizontal frames at regular intervals so that the LNB sorters can move.

Serial numbers may be assigned to the LNB sorters, respectively, the transfer conveyor may be equipped with a sorter number recognizer configured to recognize the starting number of the serial numbers assigned to the respective LNB sorters, and the transfer conveyor may further be equipped with a sorter counter configured to count the number of LNB sorters that has passed therethrough.

Each of the LNB sorters may include: a pair of side plates formed on both sides of a horizontal plate, respectively, in the lengthwise direction; roller motor covers installed on the pair of side plates, respectively, so that a roller motor can be installed on one side of the side plates; driven roller covers installed on the pair of side plates, respectively, so that a driven roller can be installed on an opposite side of the side plates; the roller motor installed between the roller motor covers; the driven roller installed between the driven roller covers; a belt rotatably installed around the roller motor and the driven roller in the form of an endless track; a cover body installed on the side plates; a wireless communicator installed on the top surface of the cover body to enable wireless communication with the server; and a power connection unit installed to come into contact with a power supply rail installed on the transfer conveyor so that it can supply power to the roller motor and the wireless communicator.

The power connection unit may include: a plurality of fixed brackets installed on the cover body; fixed links installed on first sides of the fixed brackets; a pair of connection links rotatably coupled to each of the fixed links; a spring installed between the pair of connection links spaced apart from each other so that the connection links are flexibly installed; a movable link coupled to the connection links; and power connection terminals installed to be movable by the LNB sorter while in contact with the power supply rail.

As described above, in the automatic logistics sorting apparatus including LNB sorters according to the present invention, effects are achieved in that the LNB sorters may be controlled by the wireless communicators configured to enable wireless communication with the server, the logistics sorting apparatus may be constructed in a simpler form by controlling the LNB sorters through wireless communication, and the overall structure of the automatic logistics sorting apparatus may be constructed in a simpler form.

In addition, in the automatic logistics sorting apparatus including LNB sorters according to the present invention, effects are achieved in that noise is not generated by moving the LNB sorters via the electromagnets compared to a chain or sprocket structure, a working environment for logistics transfer may be kept quieter and more comfortable, the inconvenience caused by adjusting the tension of a chain may be eliminated and also a long work time caused by the adjustment of tension may be reduced, and the automatic logistics sorting apparatus may be continuously used without worrying about breakdowns.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a front view showing an automatic logistics sorting apparatus including LNB sorters according to an embodiment of the present invention;

FIG. 2 is a plan view showing the automatic logistics sorting apparatus including LNB sorters according to the present embodiment;

FIG. 3 is a side view showing the automatic logistics sorting apparatus including LNB sorters according to the present embodiment;

FIG. 4 is a three-dimensional view showing an LNB sorter according to one embodiment of the present invention;

FIG. 5 is a three-dimensional exploded view showing the LNB sorter according to the present embodiment;

FIG. 6 is a three-dimensional bottom view showing the LNB sorter according to the present embodiment;

FIG. 7 is an exploded three-dimensional view showing the LNB sorter according to the present embodiment.

FIG. 8 is a three-dimensional view showing a power connection unit installed in an LNB sorter according to one embodiment of the present invention;

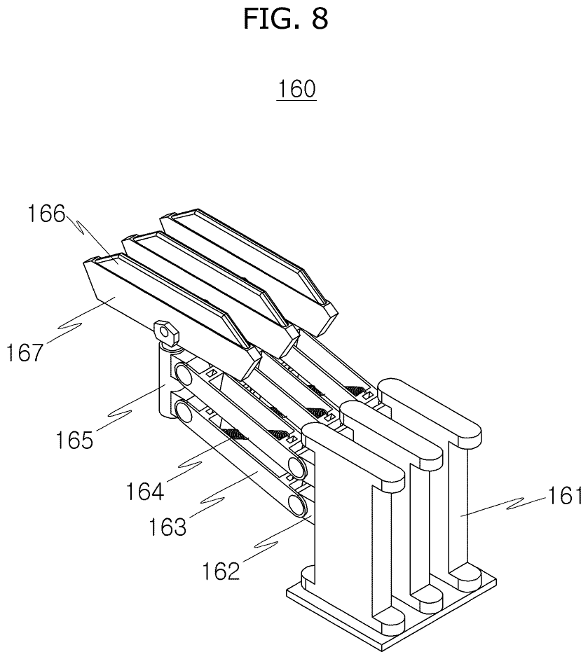

FIG. 9 is a three-dimensional exploded view showing the power connection unit installed in the LNB sorter according to the present embodiment; and

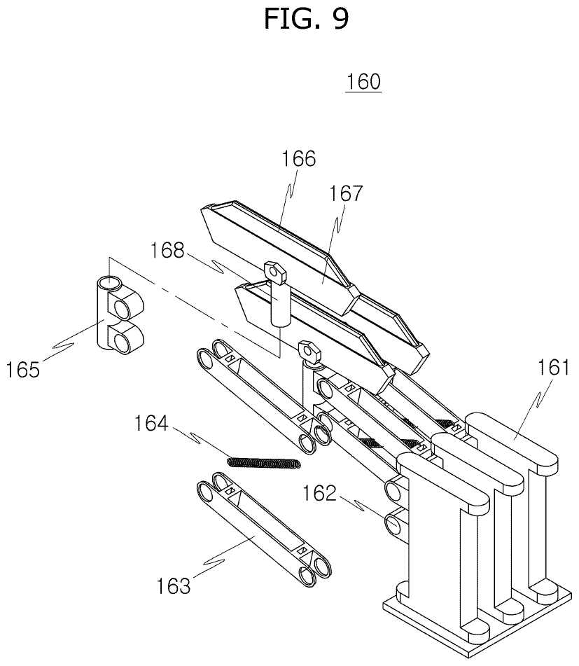

FIG. 10 is a three-dimensional partial view showing the power connection unit installed in the LNB sorter according to the present embodiment.

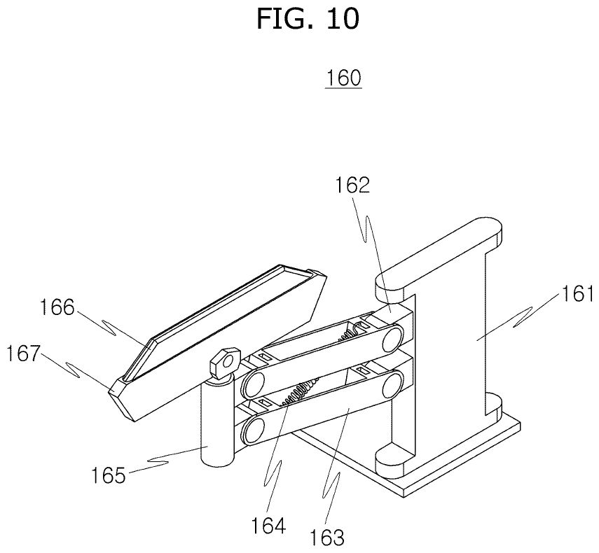

### DETAILED DESCRIPTION

Embodiments of the present invention will be described in detail below with reference to the accompanying drawings so that those of ordinary skill in the art to which the present invention pertains can easily implement the present invention.

However, the description of the present invention is only an example for structural and functional illustration, and thus, the scope of the present invention should not be construed as being limited to the embodiments described in the detailed description.

For example, the embodiments may be modified in various manner and take various forms, and thus, the scope of the present invention should be understood to include equivalents that can realize the technical spirit of the present invention.

In addition, the objects or effects presented in the present specification do not require that a specific embodiment must include all of them or include only them, so that the scope of the present invention should not be understood as being limited thereto.

In the present specification, the embodiments are provided to make the disclosure of the present invention complete and to fully inform the scope of the invention to those of ordinary skill in the art to which the present invention pertains. Furthermore, the present invention is defined only by the scope of the claims.

Accordingly, in some embodiments, well-known components, well-known operations, and well-known techniques are not specifically described in order to avoid ambiguity in the interpretation of the present invention.

Meanwhile, the meanings of the terms described in the present specifications are not limited to the dictionary meanings and should be understood as follows:

All the terms used herein, unless otherwise defined, have the same meanings as commonly understood by those of ordinary skill in the art to which the present invention pertains.

The terms defined in commonly used dictionaries should be interpreted as being consistent with meanings in the context of the relevant technology, and cannot be interpreted as having ideal or excessively formal meanings unless explicitly defined in the present specification.

An automatic logistics sorting apparatus including LNB sorters according to one embodiment of the present invention will be described in detail below with reference to the accompanying drawings.

According to one embodiment of the present invention, there is provided an automatic logistics sorting apparatus including LNB sorters, the automatic logistics sorting apparatus sorting a plurality of products while transferring the plurality of products, the automatic logistics sorting apparatus including: a transfer conveyor 110 configured such that a plurality of LNB sorters 130 spaced apart from each other by a predetermined distance are installed in the form of an endless track in order to transfer the products in one direction; LNB sorters 130 configured to sort and discharge the products in a direction orthogonal to the moving direction of the transfer conveyor 110; a wireless communicator 150 installed in each of the LNB sorters 130 in order to enable wireless communication with a server so that the products can be sorted in a direction orthogonal to the transfer conveyor 110; and a power connection unit 160 installed to supply power to the wireless communicator 150 and the roller motor 137 that are installed on the LNB sorter 130; wherein, when the LNB sorters 130 reach a sorting location for the products, the products are sorted by driving the LNB sorters 130 in response to signals received from the wireless communicators 150.

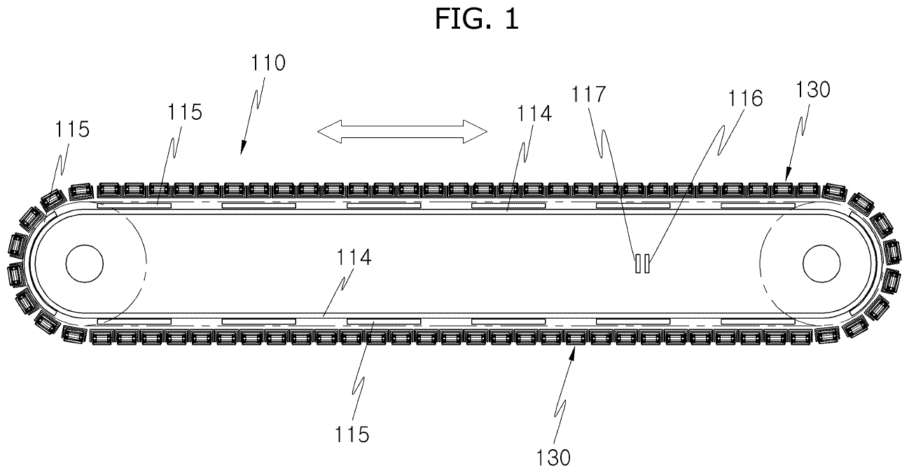

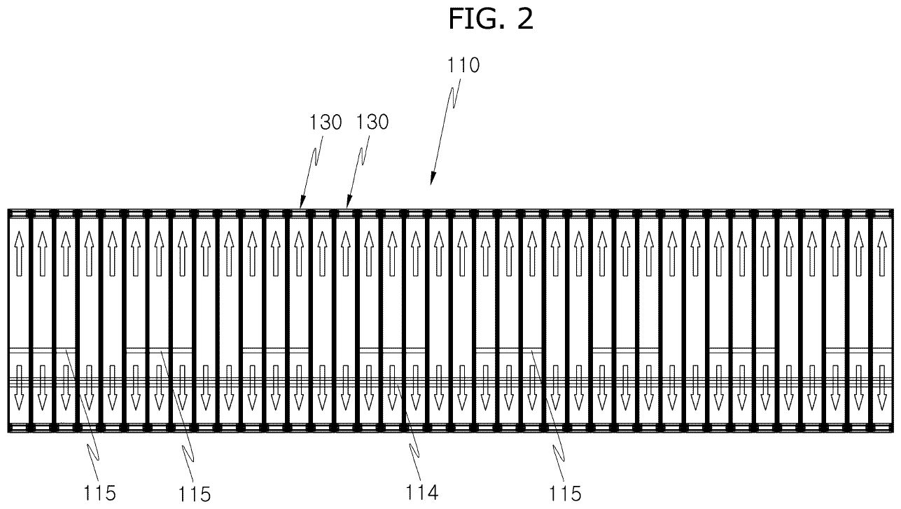

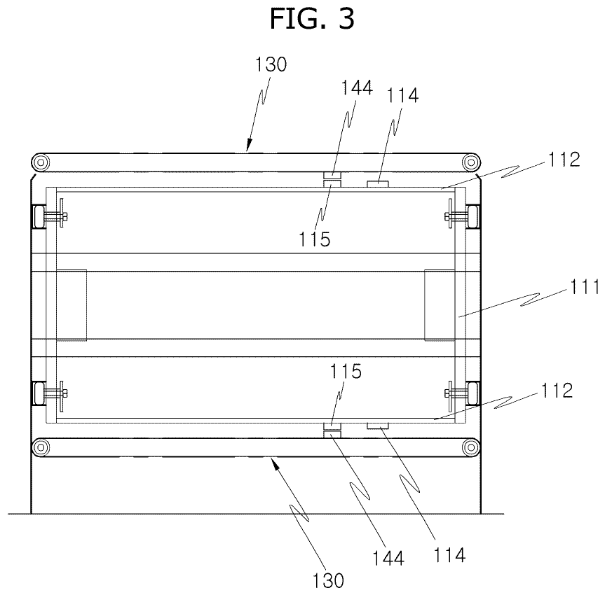

FIG. 1 is a front view showing an automatic logistics sorting apparatus including LNB sorters according to an embodiment of the present invention, FIG. 2 is a plan view showing the automatic logistics sorting apparatus including LNB sorters according to the present embodiment, and FIG. 3 is a side view showing the automatic logistics sorting apparatus including LNB sorters according to the present embodiment.

As shown in FIGS. 1 to 3, the transfer conveyer 110 of the automatic logistics sorting apparatus according to the embodiment of the present invention is configured such that a plurality of liner narrow belt (LNB) sorters 130 spaced at regular intervals are installed along an endless track to be rotatable.

In the above transfer conveyor 110, vertical frames 111 are installed on left and right sides, respectively, horizontal frames 112 are installed on the upper and lower sides of the vertical frame 111, respectively, and covers 113 are installed on both sides, respectively.

The transfer conveyor 110 includes a power supply rail 114 installed on the horizontal frames 112 in the form of an endless track so that power can be supplied to the LNB sorters 130 and transfer electromagnets 115 installed on the horizontal frames 112 at regular intervals so that the LNB sorters 130 can be moved.

In the transport conveyor 110, the power supply rail 114 forming an endless track is installed such that power can be supplied to the LNB sorters 130, and the transfer electromagnets 115 are installed on the horizontal frames 112 so that the LNB sorters 130 can be moved.

The transfer electromagnets 115 are installed at regular distance along the endless track.

N poles and S poles are formed in the transfer electromagnets 115 by applied power. When the N poles are formed as those of sorter electromagnets 144 installed in the LNB sorters 130, the LNB sorters 130 are moved by the repulsive force attributable to the same polarity formed in the sorter electromagnets 144 and the transfer electromagnets 115.

In addition, the transfer conveyor 110 is equipped with a sorter number recognizer 116 configured to recognize the first one of the LNB sorters 130 that are assigned respective serial numbers, and a sorter counter 117 configured to count the number of LNB sorters 130 that pass therethrough.

That is, the above-described transfer conveyor 110 is equipped with a first LNB sorter 130 indicative of a starting location among the number of LNB sorters 130 that move along an endless track, and the sorter number recognizer 116 configured to recognize the starting location of approximately 100 or more LNB sorters 130 in order to transfer products.

The sorter number recognizer 116 recognizes the first LNB sorter 130.

This is intended to enable the sorting of items, placed on the plurality of LNB sorters 130, to designated locations.

In addition, the sorter counter 117 configured to measure the number of LNB sorters 130 passing therethrough is installed on the transfer conveyor 110. The sorter counter 117 recognizes how many LNB sorters 130 have passed therethrough.

That is, the transfer conveyor 110 sorts and discharges products at designated locations during the transfer of the products. The transfer conveyor 110 enables the moving location of the LNB sorter 130 having passed through the sorter number recognizer 116 to be identified, so that products can be sorted at the designated locations.

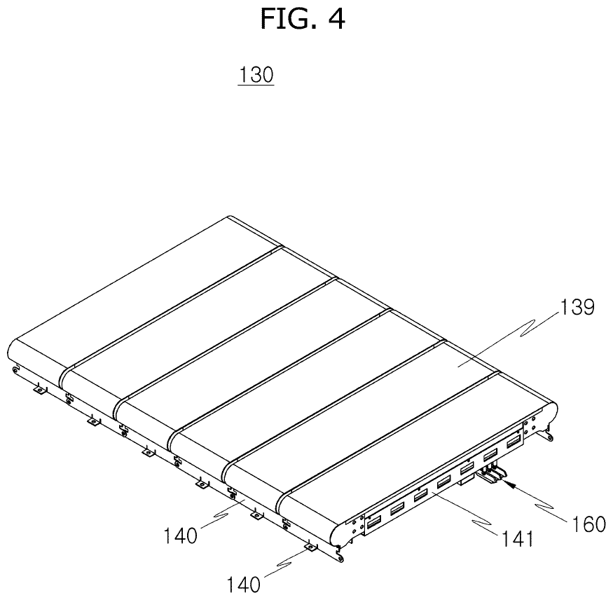

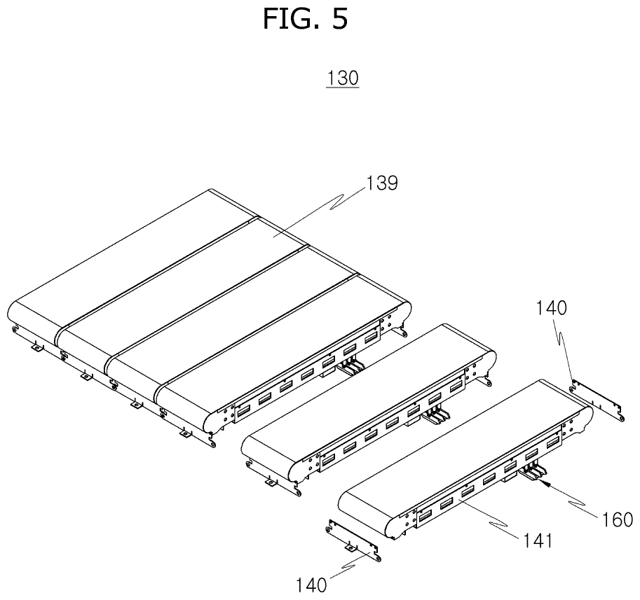

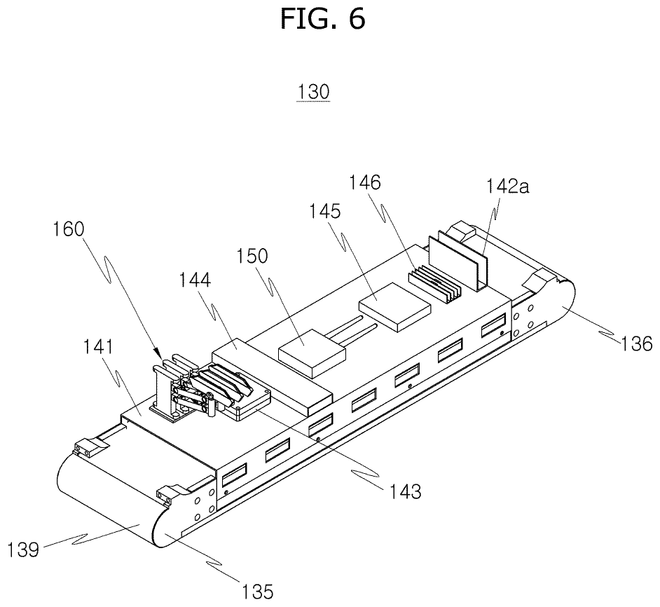

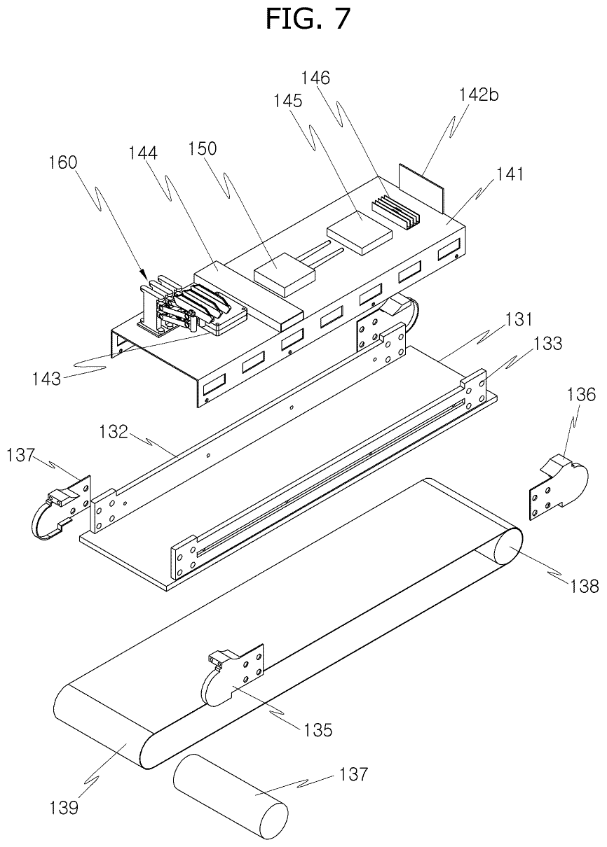

FIG. 4 is a three-dimensional view showing an LNB sorter according to one embodiment of the present invention, FIG. 5 is a three-dimensional exploded view showing the LNB sorter according to the present embodiment, FIG. 6 is a three-dimensional bottom view showing the LNB sorter according to the present embodiment, and FIG. 7 is a three-dimensional exploded view showing the LNB sorter according to the present embodiment.

As shown in FIG. 4 and FIG. 7, the LNB sorters 130 constituting the transfer conveyor 110 are each formed in a narrow shape. This is intended to enable the transfer of products regardless of their size, and may allow products to be classified while allowing products with a small size (or width) to be transferred by one LNB sorter 130 and also allowing products with a large size (or width) to be transferred by two or more sorters 130.

Each of the LNB sorters 130 may include: a pair of side plates 132 formed on both sides of a horizontal plate 131, respectively, in the lengthwise direction; roller motor covers 135 installed on the pair of side plates 132, respectively, so that a roller motor 137 can be installed on one side of the side plates 132; driven roller covers 136 installed on the pair of side plates 132, respectively, so that a driven roller 138 can be installed on the opposite side of the side plates 132; the roller motor 137 installed between the roller motor covers 135; the driven roller 138 installed between the driven roller covers 136; a belt 139 rotatably installed around the roller motor 137 and the driven roller 138 in the form of an endless track; a cover body 141 installed on the side plates 132; a wireless communicator 150 installed on the top surface of the cover body 141 to enable wireless communication with the server; and a power connection unit 160 installed to come into contact with a power supply rail 114 installed on the transfer conveyor 110 so that it can supply power to the roller motor 137 and the wireless communicator 150.

The LNB sorters 130 are configured to transfer products and classify and discharge the products to desired locations while moving along an endless track, and are formed to have the same width as the transfer conveyor 110

In the LNB sorter 130, the horizontal plate 131 is integrated with the side plates 132 on both sides of the horizontal plate 131 in the lengthwise direction.

In addition, fastening holes 133 are formed on both sides of the side plates 132 so that the covers 135 and 136 can be installed on the side plates 132.

The pair of roller motor covers 135 are installed on one side of the LNB sorter 130 so that the roller motor 137 can be installed therebetween, and the pair of driven roller covers 136 are installed on the other side, so that a driven roller 138 can be installed.

The roller motor 137 is rotatably installed between the pair of roller motor covers 135, and the driven roller 138 is rotatably installed between the pair of driven roller covers 136.

A motor (not shown) is embedded inside the roller motor 137, and a roller is driven by power supplied to the embedded motor. A conventional motor is used as the roller motor 137 (also called a “roller conveyor electric motor”), and a detailed description thereof will be omitted.

The belt 139 capable of moving products is rotatably installed on the outer surfaces of the roller motor 137 and the driven roller 138 in the form of an endless track.

In addition, connection brackets 140 configured to connect adjacent LNB sorters 130 so that they can move continuously along an endless track are provided on both sides of the LNB sorter 130.

It is obvious that a plurality of idle rollers (not shown) may be rotatably installed on the connection brackets 140.

The cover body 141 is installed on the tops of the side plates 132 (see FIGS. 6 and 7), and a serial number plate 142 is installed on one side of the cover body 141 so that a serial number attached to the LNB sorter 130 can be recognized.

The serial number plate 142a shown in FIG. 6 is installed on the first one 130 of the plurality of sorters 130, and the serial number plate 142b shown in FIG. 7 is installed in the same manner on each of all LNB sorters 130 except for the first LNB sorter 130.

That is, the serial number plate 142a installed on the first LNB sorter 130 is composed of two plates, and each of the remaining serial number plates 141b is composed of a single plate.

This is intended not only to make the recognition of the first sorter 130 easier, but also to facilitate the initialization work according to the transfer of products, that is, to facilitate initialization by matching the first LNB sorter 130 with the sorter number recognizer 116.

In addition, that enables the transfer conveyor 110 to be more easily initialized or reset during the transfer and sorting of products.

In addition, the power supply unit 143 capable of supplying power to the roller motor 137 and the wireless communicator 150 is installed on the cover body 141, and the sorter electromagnet 144 corresponding to the transfer electromagnet 115 that is not a chain or sprocket structure is installed on the LNB sorter 130.

N or S poles are formed in such the sorter electromagnets 144 by applied power, and the transfer conveyor 110 is moved by the repulsive force attributable to the polarity that is the same as that of the transfer electromagnets 115.

In addition, a roller motor controller 145 configured to control the operation of the roller motor 137 is installed on the cover body 141, and the roller motor controller 145 controls the operation of the roller motor 137 according to control signals received from the wireless communicator 150.

When the LNB sorter 130 reaches a sorting (discharging) location for products, the roller motor controller 145 rotates the belt 139 by the rotation of the roller motor 137 and the driven roller 138 by applying power to the roller motor 137.

In this case, the belt 139 may move and discharge products in the desired direction of the LNB sorter 130 by the forward and reverse rotation of the roller motor 137.

In addition, a heat sink 146 configured to release heat generated from the power supply unit 143 and the like is installed on the cover body 141, and prevents an erroneous function attributable to heat generation by cooling the heat generated from the LNB sorter 130.

The wireless communicator 150 configured to perform wireless communication with a server (not shown) is installed on the cover body 141. This wireless communicator 150 may be based on a Wi-Fi or a local area network, and the wireless communicator 150 receives a control signal transmitted from the server and transmits it to the roller motor controller 145.

Accordingly, the roller motor controller 145 drives the roller motor 137 so that a product placed on the belt 139 can be transferred to a desired location and then sorted into a desired discharge location.

The power connection unit 160 may include: a plurality of fixed brackets 161 installed on the cover body 141; fixed links 162 installed on first sides of the fixed brackets 161; a pair of connection links 163 rotatably coupled to each of the fixed links 162; a spring 164 installed between the pair of connection links 163 spaced apart from each other so that the connection links 163 are flexibly installed; a movable link 165 coupled to the connection links 163; and power connection terminals 166 installed to be movable by the LNB sorter 130 while in contact with the power supply rail 114.

The power connection unit 160 includes the plurality of fixed brackets 161, and the fixed links 162 are formed on the first sides of the fixed brackets 161 so that first sides of the connection links 163 can be rotatably connected to the fixed links 162.

The above connection links 163 are formed to having a predetermined length and are provided in pairs so that they can be brought into elastic contact with the power supply rail 114 by the elasticity of the spring 164.

The movable link 165 is coupled to the opposite sides of the connection links 163, and the power connection terminal 166 is coupled to the movable link 165.

The power connection terminal 166 comes into elastic contact with the power supply rail 114 formed as an endless track, is equipped with an insulator 167 to prevent electrical contact with another adjacent power connection terminal 166, and is provided with a fixing bar 168 to couple the power connection terminal 166 to the movable link 165.

On the horizontal frames 112 of the automatic logistics sorting apparatus including LNB sorters, the power supply rail 114 is installed in the form of an endless track, and also the transfer electromagnets 115 whose polarity is changed by an authorized power source is installed. The power connection unit 160 configured to move along the power supply rail 114 in the form of an endless track is installed in the LNB sorters 130 forming the transfer conveyor 110.

The power connection unit 160 stably supplies power to the wireless communicator 150, the roller motor 137, and the like while moving in contact with the power supply rail 114 configured in the form of an endless track.

In addition, the sorter electromagnets 144 corresponding to the transfer electromagnets 115 are installed on the LNB sorters 130, and the LNB sorters 130 are moved by the repulsive force of the electromagnets 144 formed to have the polarity that is the same as the transfer electromagnets 115.

The roller motors 137 configured to drive the belt 139 are installed on the LNB sorters 130, and the roller motors 137 are driven by the roller motor controllers 145.

Meanwhile, the sorter number recognizer 116 configured to recognize the first one 130 of the LNB sorters 130 is installed on the transfer conveyor 110, the sorter number recognizer 116 recognizes the first LNB sorter 130, and the sorter counter 117 measures the movement distance of the first LNB sorter 130 by counts the number of movements of the first LNB sorter 130.

The products to be sorted are placed on the LNB sorters 130, the LNB sorters 130 are moved by the repulsive force of the electromagnets 115 and 144, and the roller motors 137 are driven by the roller motor controllers 145 through the wireless communicators 150 installed on the LNB sorters 130.

That is, when the LNB sorter 130 on which a product is stacked reaches the location where the product is to be sorted, the wireless communicator 150 transmits a control signal to the roller motor controller 145 in response to a control signal transmitted from the server (not shown), and the roller motor 137 is driven in response to a control signal from the roller motor controller 145.

Therefore, the roller motors 137 of the LNB sorters 130 are driven, and the belt 139 is rotated, thereby discharging products to desired locations.

Although the present invention contrived by the present inventor has been specifically described according to the above embodiments, the present invention is not limited to the above embodiments, and it is obvious that various modifications may be made without departing from the technical spirit of the present invention.

What is claimed is:

1. An automatic logistics sorting apparatus including LNB sorters, the automatic logistics sorting apparatus sorting a plurality of products while transferring the plurality of products, the automatic logistics sorting apparatus comprising:
a transfer conveyor configured such that a plurality of LNB sorters spaced apart from each other by a predetermined distance are installed in an endless track form in order to transfer the products in one direction;
LNB sorters configured to sort and discharge the products in a direction orthogonal to a moving direction of the transfer conveyor;
a wireless communicator installed in each of the LNB sorters in order to enable wireless communication with a server so that the products can be sorted in a direction orthogonal to the transfer conveyor; and
a power connection unit installed to supply power to the wireless communicator and the roller motor that are installed on the LNB sorter;
wherein the transfer conveyor comprises a power supply rail installed in an endless track form on horizontal frames in order to supply power to the LNB sorters, and transfer electromagnets installed on the horizontal frames at regular intervals so that the LNB sorters can move;
wherein sorter electromagnets formed to have a predetermined length, corresponding to the transfer electromagnets formed to have a predetermined length, are installed in the LNB sorters, and the sorter electromagnets are installed in a same lengthwise direction as the transfer electromagnets, and the LNB sorters are moved in one direction by a repulsive force attributable to an identical polarity of the transfer electromagnets and the sorter electromagnets; and
wherein, when the LNB sorters reach a sorting location for the products, the products are sorted by driving the LNB sorters in response to signals received from the wireless communicators.

2. The automatic logistics sorting apparatus of claim 1, serial numbers are assigned to the LNB sorters, wherein respectively, the transfer conveyor is equipped with a sorter number recognizer configured to recognize a starting number of the serial numbers assigned to the respective LNB sorters, and the transfer conveyor is further equipped with a sorter counter configured to count a number of LNB sorters that has passed therethrough.

3. The automatic logistics sorting apparatus of claim 1, wherein each of the LNB sorters comprises:
a pair of side plates formed on both sides of a horizontal plate, respectively, in a lengthwise direction;
roller motor covers installed on the pair of side plates, respectively, so that a roller motor can be installed on one side of the side plates;
driven roller covers installed on the pair of side plates, respectively, so that a driven roller can be installed on an opposite side of the side plates;
the roller motor installed between the roller motor covers;
the driven roller installed between the driven roller covers;
a belt rotatably installed around the roller motor and the driven roller in an endless track form;
a cover body installed on the side plates;
a wireless communicator installed on a top surface of the cover body to enable wireless communication with the server; and
a power connection unit installed to come into contact with a power supply rail installed on the transfer conveyor so that it can supply power to the roller motor and the wireless communicator.

4. The automatic logistics sorting apparatus of claim 1, wherein the power connection unit comprises:
a plurality of fixed brackets installed on the cover body;
fixed links installed on first sides of the fixed brackets;
a pair of connection links rotatably coupled to each of the fixed links;
a spring installed between the pair of connection links spaced apart from each other so that the connection links are flexibly installed;
a movable link coupled to the connection links; and
power connection terminals installed to be movable by the LNB sorter while in contact with the power supply rail.
